(19) United States
(12) Patent Application Publication
(10) Pub. No.: US 2021/0392393 A1
(43) Pub. Date: Dec. 16, 2021

(54) METHOD FOR AD POD HANDLING IN LIVE MEDIA STREAMING

(71) Applicant: LIVESTREAMING SWEDEN AB, Stockholm (SE)

(72) Inventor: Ted OLSSON, Stockholm (SE)

(73) Assignee: LIVESTREAMING SWEDEN AB, Stockholm (SE)

(21) Appl. No.: 17/295,470

(22) PCT Filed: Nov. 26, 2019
(86) PCT No.: PCT/EP2019/082508

§ 371 Date: May 20, 2021

(30) Foreign Application Priority Data
Dec. 21, 2018 (SE) 1851667-4

(51) Int. Cl. H04N 21/262; H04N 21/2187; H04N 21/81; H04N 21/254; H04N 21/2668; H04N 21/24; H04N 21/234

(52) U.S. Cl. CPC H04N 21/26258; H04N 21/2187; H04N 21/812; H04N 21/23424; H04N 21/2668; H04N 21/2407; H04N 21/254

(57) ABSTRACT

There is provided a method for handling client device advertisement playlists, ad pods, and insertion of ad pods in a live or linear media content stream in a media distribution system (100) for distributing media content from a streaming source (50), e.g. a broadcast location (TV network, local TV studio, cable system, etc.) via a primary network to a streaming server (101) to client devices, when providing dynamic server-side advertisement insertion at an ad insertion server (130) which may be integrated in a streaming edge server (101) or free-standing, during live streaming of media content to a plurality of clients (151-153). The method comprises sending ad requests to an ad server (110) and pre-generating ad pods for each client in a speculative manner before an upcoming ad break is initiated. The media distribution system may typically be of IP type for live distribution of media content streams, e.g. video and/or audio, in view of which aspects of the inventive concept will be described.

### FIELD OF THE INVENTION

The present invention relates generally to providing dynamic server-side advertisement insertion during live streaming of media content to a plurality of clients, and more particularly to a method for handling client advertisement playlists, ad pods.

### BACKGROUND OF THE INVENTION

Server-side ad insertion, SSAI, is a method to transition from ongoing streaming of a live or linear media content stream to a number of client devices to a playlist of advertisements, an ad pod, on a streaming server-side when an ad break is signaled, e.g. by ad markers provided in the live media content stream by the content provider. SSAI is advantageous in that the advertisements (herein after referred to as ads or ad clips) may be inserted in the video stream in a seamless transition between the media content and the ad clips. In addition, so called dynamic ad insertion allows advertisers to serve different ads to each individual client device. Known methods for SSAI are e.g. Server-side Ad stitching (segment based) and Server-side Ad splicing (segment based). Different ad standards, like Video Ad Serving Template (VAST) or Video Multiple Ad Playlist (VMAP), may be used for requesting ads to be inserted in the media content stream. VAST and VMAP are XLM response frameworks that enable a delivery format and ad inventory insertion policy for ads across streaming video and audio platforms. When performing server-side ad insertion, an intermediary server between the streaming server and the clients is typically utilized to insert ads dynamically into the media content stream. When a client device requests for live or video-on-demand (VOD) media content from a content distribution network (CDN), an ad insertion service of the CDN may pull formatted template manifests unique for the client device, which may also comprise ad markers signaling an upcoming ad-break such that the ad insertion service can detect when to perform ad insertion in the media content stream. In response to detecting an ad marker, the ad insertion service sends an ad request to an ad decision server (ADS), which ad request typically contains client device parameters and the duration of the ad break.

In response to the ad request, the ADS provides e.g. a VAST response which includes a list of ads to be inserted in the media content stream. In order to provide more personalized ad viewing, the list of ads may be based on viewer information gathered from the client device parameters, current ad campaigns, and ad tracking URLs to report ad clips consumption to. The ad insertion service includes the URLs for the appropriate ads from the VAST or VMAP response into the manifest, and then provides the fully customized manifest to the requesting client device via the CDN (note that the CDN cannot cache the response since it is unique to the client device). As playback of the list of ads during the ad break progresses, either the ad insertion service or the video player reports how much of each ad is played. Using server-side reporting, the ad insertion service sends ad viewing reports directly to the ad tracking URL. As the client device requests ad segments throughout content playback, if the ad is not already transcoded in a format that matches the video content, the ad insertion service may transcode the ad at the time of the ad segment request. If an ad is not already transcoded, the ad insertion service doesn't present it for playback at the first request.

Server-side splicing for inserting additional content, like ads, into a live media content stream involves replacing a predetermined portion of media content in a live media stream, e.g. a live sporting event like tennis, with new content, e.g. providing an ad break when the players take breaks between each game or between sets. Splicing may be performed on a transport packet level. A splicer server performs the function of switching between the original live media content stream and an ad clip transport stream based on information present in e.g. SCTE-35 signals provided in the live media content stream (The Society of Cable Television Engineers Standard 35 (SCTE-35)), thereby producing different media content output streams containing different targeted ads that are then delivered to individual client devices e.g. via an Internet Protocol (IP) distribution network comprising a packet-based transmission medium having a plurality of edge devices (e.g. routers) to provide connectivity across a dispersed geographic region. The SCTE-35 signaling comprises ad markers, or splice information, typically corresponding to a splice out point, which is the point in the live media content stream where the splicer switches from the live media content stream to the ad clip transport stream, and a splice-in point where streaming of the ad clip transport stream ends and streaming of the live media content stream begins again. When identifying an ad marker, the splicer server utilizes this splice information to signal an associated ad server to retrieve a playlist of ads, ad pod, for insertion into the video bit stream. (In a similar manner, when utilizing client-side ad splicing an individual splicer of each client device signals an ad server to retrieve the playlist of ads). Each ad server may communicate with a centralized ad management system for handling ad scheduling, management and billing. Such an ad management system may also provide storage and access of information used to target at customers having certain demographics or viewing habits. When the ad marker is detected, the splicer server switches between the original media content stream and ads according to the ad pod bit stream. When performing splicing at transport level, this switching occurs at marked IP packet boundaries, and results in a single output stream sent to a particular targeted client device or group of client devices.

Media content providers typically have to deal with drastically changing number of client device requests with sharp peaks in demand, especially when it comes to breaking news, sports events and popular TV series, for which the number of concurrent viewers can vary greatly and unpredictably. While the systems described above are generally effective in accomplishing dynamic server-side ad insertion during live streaming of media content of a segment based streaming system, there is thus however required a highly scalable architecture to cope with fluctuations in demand for just-in-time server-side ad insertion. This is especially true for large live events which attracts large audiences. The increase in the number of requests during such events typically makes the response times from an ad request until it gets received and can be delivered from the ad splicer server longer. This creates bottlenecks and makes scalability an issue and also makes it more difficult to have a low end-to-end delay for live streaming using server-side ad insertion. There is a trend in live online streaming to try and reduce the latency to the viewers. Current CDN delivery platforms typically add 30-60 seconds of delay to OTT devices. The current ambition is to reduce this delay to equivalent or even faster than current broadcast signals. This puts further constraints on ad server technologies to cope with all simultaneous requests in a very short time period in order to not add or require extra delay to the delivery of the content streams. The ad servers might also use ad auction systems to optimize ad pricing.

### SUMMARY OF THE INVENTION

It is an object of the present invention to at least provide an at least improved dynamic server-side ad insertion method which is scalable and which can cope with fluctuations in demand for server-side ad insertion. In addition, the invention offers a low latency solution which does not add or require a long latency in the delivery of live streams to the end viewers, and further allows the ad insertion process more time to find more optimal ads corresponding to the end viewers, e.g. when ad auction systems are applied.

To better address one or more of these concerns, in a first aspect of the invention a method for server-side ad insertion is presented that instead of just-in-time requesting of ads at the moment of ad-break, provides proactive and/or speculative generation of ad pods per device which relaxes the constraints on the ad server and improves the scalability characteristics of the server-side ad insertion. This proactive generation of ad pods provides more time for ad request and ensures sufficient processing time for ads of all individual client device ad pods to be fully ready when the ad-break occurs.

This object is achieved by a method according to the present invention as defined in the appended independent claims. Preferred embodiments are set forth in the dependent claims and in the following description and drawings.

The current inventive concept is preferably utilized in the context of dynamic SSAI. Benefits of doing dynamic SSAI, as compared to client-side ad insertion, are less complex client stack, completely seamless user experience with respect to the media content stream and ads inserted in the ad-breaks which provides resistance to ad-blockers, no extra client buffering due to loading of ads, and personalized ad-pods. By performing proactive ad requests, i.e. pre-generating individual ad pods for the plurality of client devices performed before an upcoming ad break is initiated, improved scalability of the ad service interface, e.g. VAST interface, is achieved. For embodiments of the method better scalability of the reporting interface can be provided in a similar manner, and ultra-low latency can be achieved, including a first ad break for a streaming event even when there is a short time to retrieve ads using pre-loading. These and other aspects, features, and advantages of the invention will be apparent from and elucidated with reference to the embodiments described hereinafter.

Thus, according to a first aspect of the invention, there is provided a method for handling client advertisement ad pods for dynamic advertisement insertion during an ad break in live streaming of a media content stream to a plurality of client devices. The method comprises pre-generating individual ad pods for the plurality of client devices by for each client device: sending at least one ad request to an ad server, and receiving in response to each ad request an individual ad playlist (list of ad clips) for the client device from the ad server. The step of pre-generating individual ad pods for each client device is performed before an upcoming ad break, which has the benefits as described above. The ad break may be signaled by at least ad marker in the media content stream.

According to an embodiment of the method, pre-generating individual ad pods for the plurality of client devices is distributed over time. Sending the at least one ad request per client device can be performed directly after the previous ad break and buffered at the ad server or can be evenly distributed over time in between ad breaks, or the distribution can be performed as according to an algorithm to optimally distribute the requests in order to cope with filling the at least one ad pod for each end viewer before the next ad break and ensure a timely delivery without any added delay of the stream delivery. This could be an algorithm where more requests are sent for the first quantiles of the time between current and next ad break in order to provide the ad server and the ad splicing/stitching server as much time as possible to fill the ad pods without overflowing the buffers at the servers.

According to an embodiment of the method, the step of pre-generating individual ad pods for an upcoming (next) ad break is initiated directly after a current ad break is delivered.

According to an embodiment of the method, in order to be able to fill the first ad break which might come directly when starting to watch the stream, the step of sending for a client device at least one ad request is initiated: before streaming the media content stream, by individual client login of the client device, or by exhaust of a set retention time for a currently active individual ad pod of the client device.

According to an embodiment of the method, it further comprises identifying the plurality of client devices or customers/subscribers associated with the client devices. By identifying the client devices to which the streaming server provides the media content stream, e.g. before or at start of streaming said media content stream, a speculative, prepopulating of ad pods for a set of client devices that may view the media content stream is performed. The client devices may be identified e.g. by requesting/retrieving/receiving from a media content provider a set of client IDs of e.g. all customers/subscribers, all active client devices, predetermined target groups of clients identifying client data like e.g. geographical region, client profiles like interest in sports, news, culture, music, type of preferred shows etc. This client information is useful for providing a speculative pre-populated ad pod or set of ad pods per client device including e.g. regional-, national-, and local ad clips, with preferred content before the clients even sign up for a live event.

According to an embodiment of the method, the ad request comprises information regarding at least one of: ad provider, service provider, subservice provider, media stream content, e.g. theme of program, media stream objects, and information identifying the client device. The ad request per client comprises information identifying the client device, e.g. identities like IP-address and/or client device ID (client session ID).

According to an embodiment of the method, the individual (received) playlists comprises at least one of a location of ad clips to form part of the ad pod, and where to report back ad clips consumption.

According to an embodiment of the method a retention time, location of ad clips, and type of content for each individual playlist is selected in accordance with a business rule-set and/or in response to ad request information. An ad service typically provides the business rule-set. A retention time, i.e. how long an ad pod is valid and at the end of which a new ad request should update the ad pod, may be selected shorter than the time between adjacent ad breaks.

According to an embodiment of the method, it further comprises pre-loading ad clips based on the client device and corresponding individual playlist. According to an embodiment of the method, for each client device a set of queues of ad clips to be inserted, e.g. spliced or stitched, into the media content stream is formed. Preloading of ad clips and temporary storing them at the streaming server is advantageous e.g. to overcome time constraints in the first break of a live event.

According to an embodiment of the method, a length of the pre-generated ad pods is configurable, and preferably selected to cover a longest conceivable ad break.

The method provided herein is preferably performed at a streaming server providing the live streaming of the media content stream to the plurality of client devices, and according to an embodiment of the method, it further comprises detecting ad markers in the live media content stream defining at least one of start of the ad break, length of the ad break, stop of the ad break, and type of ad break, e.g. regional ad break or local ad break.

According to an embodiment of the method, it further comprises for each client device selecting an ad pod from the set of pre-generated ad pods based on the ad marker indicating one of length of ad break, regional-, national- and local ad break.

According to an embodiment of the method, it further comprises for each (active) client device providing seamless splicing of ad clips of the client device ad pod into the media content stream during a current ad break.

According to an embodiment of the method, it further comprises reporting back per client device ad pod ad clip consumption statistics. The reporting is performed in an asynchronous queue and/or spread out over a predetermined time, e.g. during time in between adjacent ad breaks.

According to an embodiment of the method, if endurance of a selected ad pod is shorter than the period of time covered by an ad break that it is being spliced into, or if no ad clips have been loaded for the ad pod, after finishing splicing of ad clips of the ad pod, the streaming server returns to one of: streaming the live media content stream, and sending a slate until the ad break is over.

According to an embodiment of the method, if a selected ad pod is longer than an ad break and the length of the ad break is known, after streaming ad clips of the ad pod that fits into the ad break to the client, the streaming server returns to streaming the live media content stream or to sending a slate until the ad break is over.

According to an embodiment of the method, if a selected ad pod is longer than an ad break and the length of the ad break is unknown, the streaming server streams all ad clips of the ad pod and subsequently returns to streaming the live media content stream, or the streaming server streams ad clips of the ad pod only until the ad break is over and cuts the remaining portion of the ad pod and returns to streaming the live media content stream.

According to an embodiment of the method, it further comprises pre-generating ad pods with different predefined ABR profiles.

According to an embodiment of the method, it further comprises for each client device, i.e. the end viewers, monitoring information of an ABR profile used for streaming media content before an upcoming ad break and selecting an ad pod with that same ABR profile or a lower ABR profile than the ABR profile before the ad break for insertion during the ad break.

According to an embodiment of the method, it further comprises changing ABR profile of the ad pod content to individual client devices based on the current network performance to that individual client device.

### BRIEF DESCRIPTION OF THE DRAWINGS

The invention will now be described in more detail and with reference to the appended drawings in which:

FIG. 1 is a schematic block diagram of an embodiment of a system for server-side ad insertion according to the present inventive concept;

FIG. 2 is a schematic block diagram of an ad insertion server according to an embodiment of the present inventive concept;

FIGS. 3a and 3b illustrate two sets of ad queues according to an embodiment of the present inventive concept;

FIG. 4 illustrates an event flow trace for an embodiment of a system for providing dynamic advertisement insertion during live streaming according to the present inventive concept; and

FIG. 5 illustrates an event flow trace for an embodiment of a system for providing dynamic advertisement insertion during live streaming according to the present inventive concept.

### DESCRIPTION OF PREFERRED EMBODIMENTS

The present invention will now be described more fully hereinafter with reference to the accompanying drawings. The below embodiments are provided by way of example so that this disclosure will be thorough and complete, and will fully convey the scope of the invention to those skilled in the art. Like numbers refer to like elements throughout.

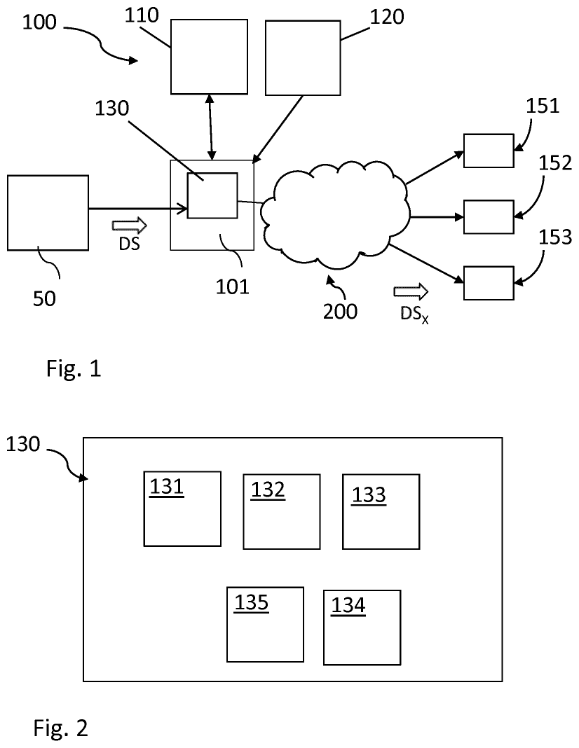

FIG. 1 is a block diagram schematically illustrating a media distribution system 100 comprising a streaming source 50, a streaming edge server 101, (the Internet and/or) a last mile network 200, multiple client devices 151-153, an ad (advertisement) server 110, and an ad clips repository 120. The media distribution system 100 may typically be of IP type for live distribution of media content streams, e.g. video and/or audio, in view of which aspects of the inventive concept will be described. From the streaming source 50, e.g. a broadcast location (TV network, local TV studio, cable system, etc.), an original encoded media content stream DS is distributed via a primary network (not shown) to the streaming server 101.

Client devices 151-153, which may be located at different viewer locations, each requests a respective media stream represented by DSx in FIG. 1 to display from the streaming server 101. The respective media streams DSₓ are transported via the network 200 over a respective communication link, which is typically provided over a computer network (e.g. a LAN a WAN, the Internet), a wireless network (e.g. a cellular data network), or some combination of these network types. The primary distribution network and the network 200 do not need to be dedicated networks but can be shared with other services.

The client devices 151-153 each comprises means for processing received media content and displaying the media content. The client devices 151-153 may be any computing device, such as smart televisions, desktops, laptops, netbooks, tablets, smart phones, or personal digital assistants.

The shown media distribution system 100 is further arranged for employing mechanisms of the present inventive concept at the streaming server 101 or in an ad insertion server 130 arranged as an integrated part of the streaming server 101 as illustrated in this exemplifying embodiment of the system, or alternatively as a dedicated intermediary server between the streaming server and the clients (not shown). The ad insertion server 130 is utilized to insert ads dynamically into the media content stream and to handle ad requests made to an ad server 110. The ad server 110 may be arranged to communicate with a centralized ad management system for handling ad scheduling, management of ads to target customers having certain demographics or viewing habits, and billing (not shown).

With reference now to FIG. 2, in accordance with an embodiment of the present invention the ad insertion server 130 comprises an ad queue manager 131, an ad handler 132, a splicer 133, a local ad pod storage 134, and a local ad queue storage 135.

The ad queue manager 131 handles ad request for the client devices 151-153. Requesting playlists of ads to be spliced into the media content stream is done to the ad server 110 which makes decisions on what client device should see which set of ads. Each ad request contains information of the individual client device, such as identifiers like IP-address and/or ID of some sort. The ad server 110 creates a corresponding playlist of ads based on business rules, such as location or type of content to be displayed. The individual ad clips and order of ad clips, i.e. permutation of lists can be up to individual basis, i.e. per client device. The ad request is preferably done over a standardized interface, e.g. VAST. The VAST may further be used for advertisement tracking. The response from the VAST request typically contains location of ad clips in the playlist, URL locations where to fetch the corresponding ad clips, and where to report back how much of the ads where consumed.

The ad insertion server 130 comprises a storage 134 in which the individual pre-generated ad pods are mapped to their respective client device or client session ID. The stored ad pods may comprise the client session ID and a list of desired ads to play. All playlists that are received in response to the ad requests are used to pre-generate ad pods which are stored. Since the ad pods are created on speculation this also applies for session IDs that are not currently active.

Based on the stored ad pods the ad handler 132 downloads ad clips from ad clips repository 120, e.g. over HTTP/HTTPS. Ad clips can be packaged as HSL or ISO BMFF file container formats. The downloaded clips are optionally converted to a system specific format and optionally stored in local ad clips storage for fast access. This pre-loading of ads is performed e.g. in order to overcome time constraints in the first break of a live event.

Ad queues contain at least one ad pod for each client. Each ad pod contains an individual composition of ad clips for each client. Multiple ad queues may be defined with different characteristics, for example length or content depending on business roles.

The splicer 133 is arranged for during ad breaks switching from the multimedia content stream DS to selected ad pods to provide updated outgoing media streams containing targeted ad clips to the client devices 151-153. The ad insertion server 130 may further be arranged to detect splice information, e.g. ad markers contained in the media content stream, e.g. in STCE-35 signaling, to identify when an ad break starts, stops, or the duration of the ad break which ad markers may serve as a trigger to splice ads into the media content stream. Other means of triggering the splicing, e.g. by means of a customized application program interface, API, is also conceivable. When an ad marker indicating an ad break start is detected in the live stream for a channel, for each of the client devices, e.g. client devices 151-153, that are currently watching the channel, its respective ad pod is checked for a desired set of ads and order of the ads to be played in the ad break. Following the order of the items in the ad pod, if the corresponding ad clip has been loaded to the ad queue egress the splicer switches the streaming source to that ad clip for playback. If the ad clip is not loaded, the next item (i.e. next ad in the ad pod) is inspected, and if the corresponding ad clips is loaded to the ad queue egress, the splicer switches the streaming source to that ad clip for playback.

Sending ad requests and reporting ad clips consumption scales with the number of concurrent client devices connected to the streaming server and if done reactively, like in prior art solutions, i.e. doing the requesting just-in-time when an ad break is signaled and reporting when the ads are consumed, both in the case of client-side or server-side ad requesting and reporting, this mean that the VAST and reporting interfaces has to scale with the number of concurrent users. This must potentially be very powerful for large events or popular linear programs.

According to the present inventive concept, instead of just-in-time requesting ads at the moment of ad-break, proactively requesting of playlists per device gives better scaling characteristics, i.e. more time for the requests and processing of the ads, which can then be fully ready when the ad-break occurs. Retention for how long time an ad pod is valid can be set depending on business rule-sets if shorter than the time between ad-breaks. The retention has also a direct relation with scaling requirements, and is preferably selected to be set evenly over time between the ads for scheduled ad-breaks or to a fixed rate for unscheduled ad-breaks.

According to an embodiment of the method, pre-generating individual ad pods further requires pre-generated ad clips with different ABR profiles/levels from the ad clip repository 120.

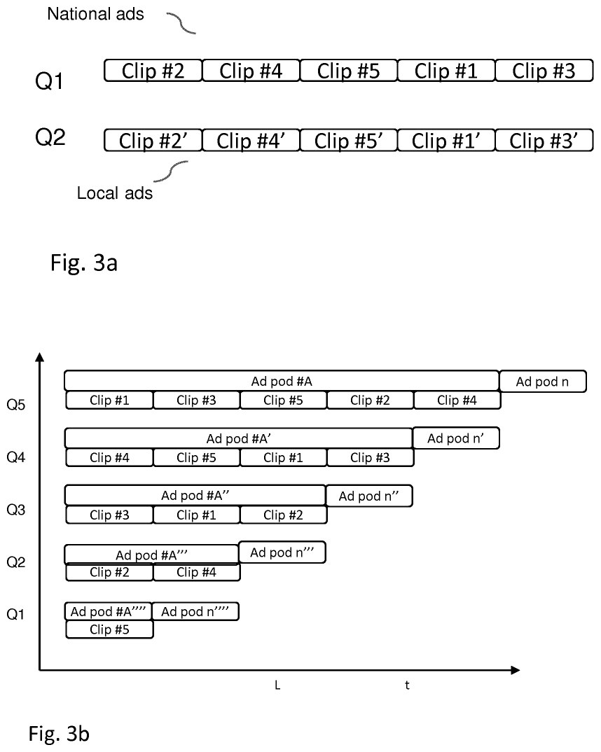

According to an embodiment of the method, pre-generating individual ad pods further comprises forming for each client device a set of ad pods to optionally be inserted/spliced into the media content stream. Thus, different versions of ad pods are pre-generated for the client according to an ad decision system. For instance, as illustrated in FIG. 3a two potential ad pods and corresponding pre-populated queues Q1, which contains national ad pods with ad clips #2, #4, #5, #1, #3, and Q2, which contains local ad pods with ad clips #2′, #4′, #5′, #1′, #3′, are generated for a client device, one containing national ads and one containing regional ads. Q1 and Q2 may also be referred to as a primary queue and a secondary queue for each client device. The decision on which of the queues, Q1 or Q2, to select for inserting/splicing into the live (or linear) feed from the streaming device during the next/upcoming ad break is then made based on e.g. information indicating at least one of length of ad break, regional-, national-, or local ad break, which information may be retrieved from the ad marker (STC-35 signaling) or e.g. a requested ABR profile from the client device (if the queues contains a matching ABR-profile).

Providing two versions of ad pods in the set will double the number of ad requests to the ad server 110, but as the ad requests made for the client devices are performed, or distributed, over the time period between ad-breaks, or before the first ad break of an event, the scaling is still significantly reduced compared to making ad requests with just-in-time signaling as in prior art. As an example: For just-in-time signaling, 1 million client devices require 1 million ad requests over typically 4 seconds since that is the time when ad-breaks are typically signaled. This means 250.000 ad requests per second are made to the ad server.

Table 1 is an illustration of how the corresponding ad request scaling for ad request signaling over time with proactive ad requests in between ad-breaks according to the current inventive concept, see e.g. the first line of Table 1, when considering 1 million ad requests which are evenly distributed over a period of 5 minutes, i.e. 300 s, in between ad breaks, which results in 3333 requests per second or 6667 requests per second for pre-generating two ad pod versions (e.g. one national and one regional).

TABLE 1

| Time in-between | Time in-between | Requests | Requests per |
|---|---|---|---|
| ad-breaks, | ad-breaks, | per | second, national |
| minutes | seconds | second | and regional |
| 5 | 300 | 3333 | 6667 |
| 10 | 600 | 1667 | 3333 |
| 20 | 1200 | 833 | 1667 |
| 30 | 1800 | 556 | 1111 |

The distribution of the ad requests may be performed e.g. by continuously sending requests looping a list of client-IDs to the ad server (ad decision platform) while controlling time between subsequent requests, i.e. the distribution of requests. Reporting is typically done synchronous for server-side just-in-time implementations. For proactive requests as presented herein, an asynchronous queue adjusts the feedback depending on the scalability of receiver, or the reporting function reports back per client device ad pod ad clip consumption statistics spread out over a predetermined time.

Referring now to FIG. 3b, a set of five ad queues Q1-Q5 is illustrated, which contains ad pods #A, #A′, #A″, #A′″, #A″″, formed from different subsets and permutations of ad clips #1, #2, #3, #4, and #5, and n, n′, n″, n′″, n″″. All individual ad pods for all client devices are placed in one queue. When defining a plurality of queues like in the shown example in FIG. 3b, each queue Q1-Q5 contains ad pods for each client device, but each queue represents ad pods with different composition. The ad pods have here been composed to represent different length L of their total playout time, such that each ad pod covers a predetermined time period, which preferably is selected to a best fit with respect to the total time length of an upcoming ad break. Thus, when the ad insertion server 130 detects an ad marker in the live or linear media content stream, an ad queue with corresponding ad pods for each client device can be selected that matches the expected length of the ad break.

According to embodiments of the method presented herein, any mismatch between the length of the selected ad pod to be inserted in the live or linear media content stream during a specific ad break must be handled. In case a selected ad pod is shorter than the predetermined ad break, or if none or some of the ad clips in that ad pod have not been loaded (or have been processed to a requested format), after finishing inserting/splicing of available ad clips of the ad pod, the streaming server (or splicer) returns to one of: streaming the live media content stream, and sending/streaming a slate until the predetermined ad break is over.

Further, in the opposite situation, that is if a selected ad pod is longer than the predetermined ad break and the length of the predetermined ad break is known, after streaming available ad clips of the selected ad pod that fits into the predetermined ad break, thus discarding any remaining ad clip that does not fit into the remaining time of the ad break, the streaming server returns to streaming the live media content stream or to sending a slate until the predetermined ad break is over.

In a third scenario, if a selected ad pod is longer than the predetermined ad break and the length of the ad break is unknown, the streaming server streams all available ad clips of the selected ad pod and subsequently returns to streaming the live media content stream, or the streaming server streams ad clips of the selected ad pod only until the predetermined ad break is over and then cuts/discards the remaining portion of the ad pod and returns to streaming the live media content stream.

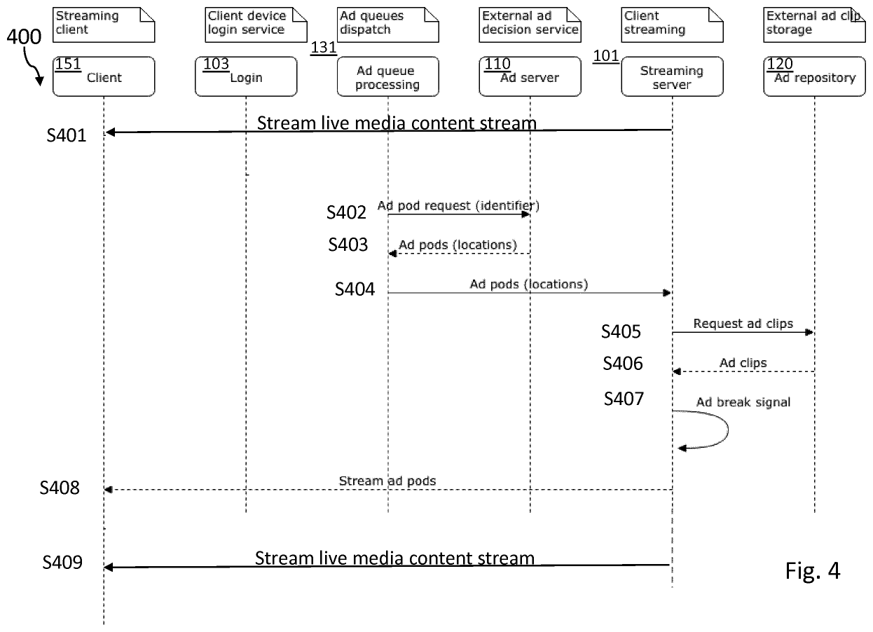

FIG. 4 illustrates an event flow trace 400 for the exemplifying system for providing dynamic advertisement insertion during live streaming described herein with reference to FIG. 1, from which system the following units are represented in the event flow trace: client device 151, login manager 103, ad queue manager 131, ad server 110, streaming server 101, and ad repository 120, which are illustrated in boxes along the top portion of FIG. 4. Further, time is represented by vertical lines descending from the boxes. Interactions between the units are represented by horizontal arrows. Other embodiments of the method may include different units, perform transactions in different orders, and/or perform different interactions. Likewise, the functions described herein may be performed by other units in other embodiments.

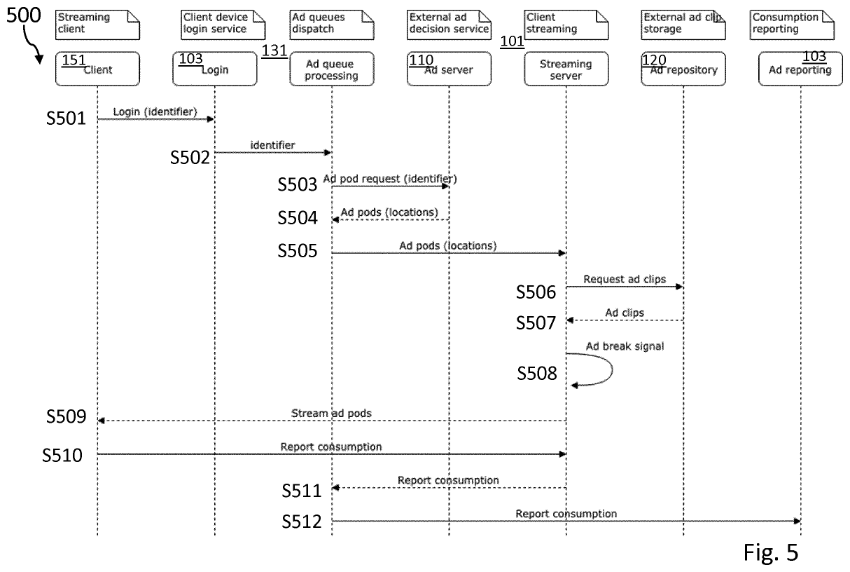

As illustrated in FIG. 4, initially the streaming server 101 streams live media content stream to client 151 (subsequent to receiving a client device 151 media content request (not shown)), (step 401). In order to provide a (or optionally a set of) pre-generated advertisement playlist for client device 151, the queue manager 130 sends at least one ad request e.g. a VAST request comprising an identifier of the client device to the ad server 110, (step 402). In response the ad server 110 provides the ad queue manager 131 with at least one playlist of ads to form at least one corresponding pre-generated ad pod, (step 403). The at least one playlist comprises locations of ad clips of the ad pod, i.e. the URL where to retrieve ad clips. The ad pod is communicated to the streaming server 101 (which here comprises the ad insertion server/splicing function), (step 404). The streaming server 101 requests the ad clips of the at least one pre-generated ad pods from the ad repository 120, (step 405), and in return receives the requested ad clips from the ad repository 120, (step 406) and forms at least one ad pod in a queue Q. At detecting an ad break signal, (step 407), the splicing function of the streaming server 101 switches to streaming the ad clips of the pre-generated ad pod during the ad break, (step 408). When the ad break is over, the streaming server returns to streaming live media content stream again, (step 409). Step 402 of sending for the client device 151 at least one ad request is thus performed before the ad break is initiated (step 407). Ad request may be initiated e.g. before step 401, or at start of streaming the media content stream (step 401), by a client login of the client device, as illustrated in FIG. 5, or by exhaust of a set retention time for an individual pre-generated ad pod of the client device.

FIG. 5 illustrates an embodiment of the method disclosed herein in an event flow trace 500 for the exemplifying system for providing dynamic advertisement insertion during live streaming described herein with reference to FIG. 1, from which system the following units are represented in the event trace: client device 151, login manager 103, ad queue manager 131, ad server 110, streaming server 101, ad repository 120, and an ad reporting manager 104 which are illustrated in boxes along the top of FIG. 5. As in FIG. 4, time is represented by vertical lines descending from the boxes. Interactions between the units are represented by horizontal arrows. Other embodiments of the method may include different units, perform transactions in different orders, and/or perform different interactions. Likewise, the functions described herein may be performed by other units in other embodiments.

As illustrated in FIG. 5, initially the client device performs a login call to the login manager 103, (step 501), the login manager 103 passes a received client device identifier contained in the client login call to the ad queue manager 131, (step 502), which triggers the queue manager 130 to provide a (or optionally a set of) pre-generated advertisement playlist for client device 151 by the queue manager 130 sending at least one ad request comprising e.g. the identifier of the client device to the ad server 110, (step 503), which in response to the at least one ad request responds to the ad queue manager 131 with at least one playlist to form the pre-generated ad pod to the queue manager 131, (step 504). The at least one playlist comprises locations of ad clips of the ad pod, i.e. the URL where to retrieve ad clips. The pre-generated ad pod is communicated to the streaming server 101 (which here comprises the ad insertion server/splicing function), (step 505). The streaming server 101 requests the ad clips of the at least one pre-generated ad pods from the ad repository 120, (step 506), and in return receives the requested ad clips from the ad repository 120, (step 507) and forms at least one ad clips queue Q. At detecting an ad break signal in a live media content stream being streamed by the streaming server, (step 508), the splicing function of the streaming server 101 switches to streaming the ad clips of the pre-generated ad pod during the ad break, (step 509). When the ad break is over, the streaming server returns to streaming live media content stream again, (not shown in FIG. 5). To report back ad clips consumption to the ad management system, the client device optionally sends an ad clips consumption report to the streaming server 101, (step 510), which sends the report consumption using the ad queue manager 131, (step 511). Finally, a report of the consumption is sent to the ad reporting manager 104, (step 512).

According to an embodiment of the method, the method further comprises identifying the plurality of client devices which may be expected to login to the media distribution system, or which may be expected to send a request for media content to the streaming server e.g. by retrieving such information from a media content provider of the media distribution system. The media content provider may provide an identification list containing at least one of registered customer, active client devices, specific target groups of customers associated with e.g. sports, news, culture, music style, geographical region, preferred type of movies or programs. With the knowledge of a group of clients the process of providing pre-generated ad pods per client device of the group of client devices is then initiated. The pre-generated ad pods may then be utilized to prepopulate individual playlists or ad pods, queues, or sets of individual playlists or ad pods, queues by prefetching ad clips to add to the queues.

Those skilled in the art will appreciate that there are various logic implementations by which processes and/or systems described herein can be implemented e.g. by hardware, software, and/or firmware. Further, subject matter described herein may be implemented via Application Specific Integrated Circuits (ASICs), Field Programmable Gate Arrays (FPGAs), digital signal processors (DSPs), other integrated formats, or in whole or in part equivalently implemented in standard integrated circuits, as one or more computer programs running on one or more computers, on one or more processors or a microprocessor, as firmware, or as virtually any combination thereof. In addition, those skilled in the art will appreciate that the mechanisms of the subject matter described herein are capable of being distributed as a program product in a variety of forms which may be stored on recordable type media such as floppy disks, hard disk drives, CD ROMs, digital tape, flash drives, SD cards, solid state fixed or removable storage, and computer memory. While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A method for handling client advertisement ad pods for dynamic server-side advertisement insertion during an ad break in live streaming of a media content stream to a plurality of client devices, said method comprising:
pre-generating individual ad pods for each client device of said plurality of client devices by:
sending at least one ad request to an ad server; and
receiving in response to each ad request an individual ad playlist for the client device from said ad server.

2. The method of claim 1, wherein said step of pre-generating individual ad pods for said plurality of client devices is distributed over time.

3. The method of claim 1, wherein said step of sending for a client device at least one ad request is initiated:
before streaming said media content stream,
by a client login of said client device,
directly after a current ad break is delivered, or
by exhaust of a set retention time for an individual ad pod of said client device.

4. The method of claim 1, wherein a retention time, location of ad clips, and type of content for each individual ad pod is selected in accordance with a business rule-set and/or in response to ad request information.

5. The method of claim 1, wherein said ad request comprises information regarding at least one of: ad provider, service provider, subservice provider, media stream content, media stream objects, and information identifying the client device.

6. The method of claim 1, further comprising pre-loading ad clips based on said client devices with corresponding ad pods.

7. The method of claim 1, wherein pre-generating individual ad pods further comprises forming for each client device a set of ad pods.

8. The method of claim 7, further comprising for each client device selecting an ad pod to be inserted into a predetermined ad break from said set based on information indicating at least one of length of ad break, regional-, national-, or local ad break, and requested ABR profile.

9. The method of claim 7, wherein if a selected ad pod is shorter than the predetermined ad break, or if none or some of the ad clips have not been loaded for the selected ad pod, after finishing inserting/splicing of ad clips of the ad pod, the streaming server returns to one of:
streaming said live media content stream, and
sending/streaming a slate until the predetermined ad break is over.

10. The method of claim 7, wherein if a selected ad pod is longer than the predetermined ad break and the length of the predetermined ad break is known, after streaming ad clips of the selected ad pod that fits into the predetermined ad break, the streaming server returns to streaming said live media content stream or to sending a slate until the predetermined ad break is over.

11. The method of claim 7, wherein if a selected ad pod is longer than the predetermined ad break and the length of the ad break is unknown, the streaming server streams all ad clips of the selected ad pod and subsequently returns to streaming said live media content stream, or the streaming server streams ad clips of the selected ad pod only until the predetermined ad break is over and cuts the remaining portion of the ad pod and returns to streaming the live media content stream.

12. The method of claim 1, further comprising reporting back per client device ad pod ad clip consumption statistics, wherein said reporting is performed in an asynchronous queue and/or spread out over a predetermined time.

13. The method of claim 1, further comprising pre-generating ad pods with different predefined ABR profiles.

14. The method of claim 1, further comprising for each client device monitoring information of an ABR profile used for streaming media content before an upcoming ad break and selecting an ad pod with the same ABR profile or a lower ABR profile for insertion during said ad break.

15. The method of claim 1, further comprising changing ABR profile of the ad pod content to individual client devices based on the current network performance to that individual client device.

16. A server configured to handle client advertisement ad pods for dynamic server-side advertisement insertion during an ad break in live streaming of a media content stream to a plurality of client devices, the server comprising:
memory configured to store computer-executable instructions; and
at least one computer processor configured to access the memory and execute the computer-executable instructions to:
pre-generate individual ad pods for each client device of said plurality of client devices by:
sending at least one ad request to an ad server; and
receiving in response to each ad request an individual ad playlist for the client device from said ad server.

17. The server of claim 16, wherein said step of pre-generating individual ad pods for said plurality of client devices is distributed over time.

18. The server of claim 16, wherein said step of sending for a client device at least one ad request is initiated:
before streaming said media content stream,
by a client login of said client device,
directly after a current ad break is delivered, or
by exhaust of a set retention time for an individual ad pod of said client device.

19. The server of claim 16, wherein a retention time, location of ad clips, and type of content for each individual ad pod is selected in accordance with a business rule-set and/or in response to ad request information.

20. The server of claim 16, wherein said ad request comprises information regarding at least one of: ad provider, service provider, subservice provider, media stream content, media stream objects, and information identifying the client device.
